(19) United States
(12) Patent Application Publication
(10) Pub. No.: US 2018/0208464 A1
(43) Pub. Date: Jul. 26, 2018

(54) PLASMA DEVICES FOR HYDROCARBON REFORMATION

(71) Applicant: KING ABDULLAH UNIVERSITY OF SCIENCE AND TECHNOLOGY, Thuwal (SA)

(72) Inventor: Min Suk CHA, Thuwal (SA)

(21) Appl. No.: 15/746,943

(22) PCT Filed: Aug. 5, 2016
(86) PCT No.: PCT/IB2016/054749

§ 371 Date: Jan. 23, 2018

Related U.S. Application Data
(60) Provisional application No. 62/202,462, filed on Aug. 7, 2015.
(60) Provisional application No. 62/202,441, filed on Aug. 7, 2015.

(51) Int. Cl. C01B 3/34; H05H 1/26

(52) U.S. Cl. CPC C01B 3/342; C01B 2203/0861; C01B 2203/0205; H05H 1/26

(57) ABSTRACT

Plasma devices for hydrocarbon reformation are provided. Methods of using the devices for hydrocarbon reformation are also provided. The devices can include a liquid container to receive a hydrocarbon source, and a plasma torch configured to be submerged in the liquid. The plasma plume from the plasma torch can cause reformation of the hydrocarbon. The device can use a variety of plasma torches that can be arranged in a variety of positions in the liquid container. The devices can be used for the reformation of gaseous hydrocarbons and/or liquid hydrocarbons. The reformation can produce methane, lower hydrocarbons, higher hydrocarbons, hydrogen gas, water, carbon dioxide, carbon monoxide, or a combination thereof.

### CROSS-REFERENCE TO RELATED APPLICATIONS

This application claims priority to, and the benefit of, co-pending U.S. provisional application entitled “PLASMA DEVICES FOR HYDROCARBON REFORMATION” having Ser. No. 62/202,462, filed Aug. 7, 2015 and co-pending U.S. provisional application entitled “METHODS FOR REFORMATION OF GASEOUS HYDROCARBONS USING ELECTRICAL DISCHARGE” having Ser. No. 62/202,441, filed Aug. 7, 2015, the contents of which are incorporated by reference in their entirety.

### TECHNICAL FIELD

The present disclosure generally relates to devices for the reformation of hydrocarbons.

### BACKGROUND

Today, the importance of renewable and alternative energy is gaining increasing attention due to the depletion of fossil fuel and the serious environmental problems caused by the excessive consumption of fossil fuel. It is required to use low-grade fuels having low calorific values to produce clean fuels and value-added chemicals.

Accordingly, there is a need for improved devices and methods for hydrocarbon reformation.

### SUMMARY

We provide improved devices and methods for hydrocarbon reformation. In certain embodiments, this disclosure describes various plasma based devices for hydrocarbon reformation, including gaseous hydrocarbons and/or liquid hydrocarbons. The devices can provide for rapid cooling of reaction temperature, controlling radical quenching reactions, and/or products separation. The methods can be used for improving the efficiency of hydrogen production and value-added chemicals such as ethylene production.

In various aspects, a device for hydrocarbon reformation is provided. The device can include a liquid container configured to hold a liquid and to receive the hydrocarbon from a hydrocarbon source. The device can also include a plasma torch in the liquid container configured to be submerged in the liquid, wherein a plasma plume from the plasma torch causes reformation of the hydrocarbon.

A plasma torch can be positioned at various locations within the liquid container. In various aspects, a plasma torch is near the bottom portion of the container and the configured to be upwardly submerged in the liquid; a plasma torch is near the top portion of the container and configured to be downwardly submerged in the liquid, a plasma torch is near a side portion of the container and configured to be laterally submerged in the liquid, or a combination thereof. In various aspects, the device includes more than one plasma torch each near a different side portion of the container and configured to be laterally submerged in the liquid. The plasma torch can be positioned or configured such as to generate mixing in the liquid when in the liquid container.

The device can include various other features. For example, in some embodiments the device includes one or more perforate plates positioned within the plasma plume of a plasma torch. In various aspects, the device includes one or more fluid inlets having an inlet valve, one or more fluid outlets having an outlet valve, one or more outlets to allow for venting and/or removal of gases, or a combination thereof.

In some embodiments, the hydrocarbon source is a liquid hydrocarbon source. In some embodiments, the hydrocarbon source is a gaseous hydrocarbon source. In various aspects, the device includes a gas bubble generator. In some aspects, the gas bubble generator is fluidly connected to the gaseous hydrocarbon source, is fluidly connected to an additive gas source, or a combination thereof. In various aspects, the gas bubble generator is configured to generate gas bubbles that pass through the liquid and into the plasma plume of a plasma torch when the liquid is in the liquid container.

Methods of hydrocarbon reformation are also provided using any of the devices provided herein. In various embodiments, the methods include introducing the hydrocarbon into the liquid container of the device, and applying a plasma plume of a plasma torch to the hydrocarbon to cause reformation of the hydrocarbon. This can be accomplished in various ways, e.g. introducing a liquid hydrocarbon into a liquid in the liquid container and/or introducing a gaseous hydrocarbon into a liquid in the liquid container. In various aspects, the methods include introducing an additive gas into the liquid container prior to or while applying the plasma plume of the plasma torch to the hydrocarbon. The additive gas can include, for example, molecular oxygen (O₂), carbon dioxide (CO₂), a mixture thereof, or a mixture with one or more additional gases. In various aspects, the hydrocarbon is a gaseous hydrocarbon and the method further includes cooling the liquid and/or the bubble at a rate of about 10⁸ K/s to 10¹⁰ K/s.

In various aspects, the reformation of hydrocarbons can produce lower hydrocarbons such as ethane, ethylene, propane, propylene, or mixtures thereof. The methods can produce a mixture of gases known as syngas. In various aspects, the reformation of the hydrocarbon produces about 15 mol-% or less of CO₂ and H₂O. In some aspects, the reformation of the hydrocarbon produces about 20 mol-% or more of the lower hydrocarbon. In various aspects, the reformation of the hydrocarbon produces about 60% mol-% or more of H₂.

Other systems, methods, features, and advantages of the present disclosure for plasma devices for hydrocarbon reformation will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram of one embodiment of a plasma device for hydrocarbon reformation including a single plasma torch upwardly submerged in a liquid near the bottom of the liquid container.

FIG. 2 is a diagram of one embodiment of a plasma device for hydrocarbon reformation including a single plasma torch upwardly submerged in a liquid near the bottom of the liquid container and having a perforated plate positioned in the plasma plume.

FIG. 3 is a diagram of one embodiment of a plasma device for hydrocarbon reformation including a single plasma torch downwardly submerged in a liquid near the top of the liquid container.

FIG. 4 is a diagram of one embodiment of a plasma device for hydrocarbon reformation including a single plasma torch laterally submerged in a liquid near one side of the liquid container.

FIG. 5 is a top view of one embodiment of a plasma device for hydrocarbon reformation having four plasma torches each submerged laterally in a liquid near different sides of the liquid container.

FIG. 6 is a diagram of a method for plasma based gaseous hydrocarbon reforming in an aqueous medium.

### DETAILED DESCRIPTION

Described below are various embodiments of devices and methods for reformation of hydrocarbons based on plasma torches in a liquid, preferably water or an aqueous medium. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

### Discussion

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic inorganic chemistry, analytical chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar. Standard temperature and pressure are defined as 0° C. and 1 bar.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

### Definitions

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

The terms “reformation” and “reforming”, as used interchangeably herein, refer to the process of converting a hydrocarbon to methane, lower hydrocarbons, higher hydrocarbons, oxygenates, hydrogen gas, water, carbon dioxide, carbon monoxide, and combinations thereof. The process can include converting at least about 20 mol. %, 30 mol. %, 40 mol. %, 50 mol. % 60 mol. %, 70 mol. %, 80 mol. %, 85 mol. %, 90 mol. %, 95 mol. %, 98 mol. %, or more of the hydrocarbon into methane, lower hydrocarbons, higher hydrocarbons, hydrogen gas, water, carbon dioxide, carbon monoxide, or a combination thereof. Reformation can convert hydrocarbons into a value added hydrocarbon mixture such as ethylene, naptha, gasoline, kerosene, or diesel oil.

The term “hydrocarbon”, as used herein, refers generally to any saturated on unsaturated compound including at least carbon and hydrogen and, optionally, one or more additional atoms. Additional atoms can include oxygen, nitrogen, sulfur, or other heteroatoms. In some embodiments the hydrocarbon includes only carbon and hydrogen. The hydrocarbon can be a pure hydrocarbon, meaning the hydrocarbon is made of only carbon and hydrogen atoms. The term “hydrocarbon” includes saturated aliphatic groups (i.e., an alkane), including straight-chain alkanes, branched-chain alkanes, cycloalkanes, alkyl-substituted cycloalkanes, and cycloalkyl-substituted alkanes. In preferred embodiments, a straight chain or branched chain alkane has 30 or fewer carbon atoms in its backbone (e.g., C₁-C₃₀ for straight chains, and C₃-C₃₀ for branched chains), preferably 20 or fewer, more preferably 15 or fewer, most preferably 10 or fewer. Likewise, preferred cycloalkanes have 3-10 carbon atoms in their ring structure, and more preferably have 5, 6, or 7 carbons in the ring structure. The term “hydrocarbon” (or “lower hydrocarbon”) as used throughout the specification, examples, and claims is intended to include both “unsubstituted alkanes” and “substituted alkanes”, the latter of which refers to alkanes having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, phosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

The term “lower hydrocarbon”, as used herein, refers generally to a hydrocarbon having a lower overall number of carbon atoms or a lower overall molecular weight as compared to a reference hydrocarbon. Unless the number of carbons is otherwise specified, “lower hydrocarbon” as used herein includes “lower alkanes”, “lower alkenes”, and “lower alkynes” having from one to ten carbons, from one to six carbon atoms, or from one to four carbon atoms in its backbone structure. The lower hydrocarbon can include ethane, ethene, propane, and propene, heptane, octane, optionally including one or more substitutents or heteroatoms, as well as derivatives thereof.

The term “higher hydrocarbon”, as used herein, refers generally to a hydrocarbon having a higher overall number of carbon atoms or a higher overall molecular weight as compared to a reference hydrocarbon. Unless the number of carbons is otherwise specified, “high hydrocarbon” as used herein can include “higher alkanes”, “higher alkenes”, and “higher alkynes” having from two to twenty carbon atoms, four to twenty carbon atoms, four to eighteen carbon atoms, six to eighteen carbon atoms, or from ten to eighteen carbon atoms. Higher hydrocarbons can include alkanes and cycloalkanes having from five to twelve carbon atoms and commonly found in petrol. Higher hydrocarbons can include alkanes have more than twelve carbon atoms, e.g. from twelve to thirty or from twelve to twenty carbon atoms and commonly found in diesel oil.

The term “oxygenate”, as used herein, refers to the corresponding hydrocarbon, lower hydrocarbon, or higher hydrocarbon wherein one or more hydrogen atoms has been substituted with an —OH substituent to form an alcohol.

The term “naptha”, as used herein, refers to a mixture of hydrocarbons containing predominately hydrocarbons having from five to ten carbon atoms. Naptha can have a boiling temperature from 30° C. to 200° C., from 40° C. to 190° C., or from 50° C. to 180° C. Naptha can include “light naptha” or “heavy naptha”. The term “light naptha” refers to mixtures of hydrocarbons containing predominately hydrocarbons have five or six carbon atoms and having a boiling point from 30° C. to 90° C. or from 30° to 80° C. The term “heavy naptha” refers to mixtures of hydrocarbons containing predominately hydrocarbons having from six to twelve, from seven to twelve, or from eight to ten carbon atoms and having a boiling point from 90° C. to 200° C., from 100° C. to 200° C., or from 120° C. to 180° C.

The term “gasoline”, as used herein, refers to a mixture of hydrocarbons containing predominately hydrocarbons having from five to twelve or from six to ten carbon atoms and a boiling point from 25° C. to 200° C. or from 50° C. to 150° C.

The term “kerosene”, as used herein, refers to a mixture of hydrocarbons containing predominately hydrocarbons having from twelve to fifteen carbon atoms and a boiling point from 200° C. to 300° C.

The terms “diesel” and “diesel oil”, as used interchangeably herein, refer to mixture of hydrocarbons containing predominately hydrocarbons having from eleven to twenty carbon atoms or from twelve to eighteen carbon atoms. Diesel oil can have a boiling point from 150° C. to 400° C. or from 175° C. to 350° C.

Suitable heteroatoms can include, but are not limited to, O, N, Si, P, Se, B, and S, wherein the phosphorous and sulfur atoms are optionally oxidized, and the nitrogen heteroatom is optionally quaternized. Heteroatoms such as nitrogen may have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e. a compound that does not spontaneously undergo transformation such as by rearrangement, cyclization, elimination, etc.

The term “substituted” as used herein, refers to all permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, preferably 1-14, 1-12, or 1-6 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C3-C20 cyclic, substituted C3-C20 cyclic, heterocyclic, substituted heterocyclic, aminoacid, peptide, and polypeptide groups.

In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms such as nitrogen may have hydrogen substituents and/or any permissible substituents of organic compounds described herein which satisfy the valencies of the heteroatoms.

In various embodiments, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

The terms “syngas” and “synthesis gas”, as used interchangeably herein, refer to a gas mixture containing mostly hydrogen (H₂) gas and carbon monoxide (CO) gas and about 20 mol-%, 15 mol-%, 12 mol-%, 10 mol-%, 8 mol-%, 6 mol-%, 5 mol-%, or less of other components such as molecular oxygen (O₂), carbon dioxide (CO₂) gas and gases of lower hydrocarbons. The syngas can have about 5 mol-%, 3 mol-%, 2 mol-%, 1 mol-%, or 0.5 mol-% of molecular oxygen. The syngas can have about 15 mol-%, 10 mol-%, 8 mol-%, 6 mol-%, 5 mol-%, 4 mol-%, 3 mol-%, 2 mol-%, or less of carbon dioxide.

The term “high melting point”, when referring to a metal or metal alloy herein, means a metal or metal alloy having a melting point that is about 800° C., 900° C., 1000° C., 1200° C., 1500° C., 2000° C., 2500° C. or higher.

### Description

### Plasma Devices for Hydrocarbon Reformation

Plasma devices for hydrocarbon reformation are provided. The devices can be used for the reformation of one or both of gaseous hydrocarbon and liquid hydrocarbons. The devices can include a liquid container having one or more plasma torches in the liquid container and configured to be submerged in a liquid within the container. A plasma plume from the plasma torch can cause reformation of the hydrocarbon, e.g. electron impact reaction and/or thermal reaction from the plasma plume can cause reformation of the hydrocarbon.

The plasma torch can be any plasma torch capable of generating the high temperature plasmas needed for the reformation process, especially those capable of generating a homogeneous, volumetric plasma at elevated pressures. The plasma torch can be an arc torch with DC or AC power, a radio frequency (RF) plasma torch, a micro-wave (MW) plasma torch, or a combination thereof. The plasma torch can include a nozzle fitted in a nozzle holder. Both the nozzle and nozzle holder can include cooling ducts, connected to each other, and to a source of coolant such as water, so that direct cooling of the nozzle can be achieved. To avoid leakage, seals can be fitted between the nozzle and nozzle holder. Plasma torches can include a cathode of highly refractory metal and an anode near it, and a source of voltage to pass an arc between the electrodes. The metal can include iron, copper, tungsten, gold, platinum, or alloys or combinations thereof. The source of voltage can be a DC power source, an AC power source, or a pulsed power source. A gas passing into the arc can form the plasma plume, e.g. the arc can cause disassociation of molecules in the gas to produce the plasma plume. A plasma torch is said to be submerged in a liquid when at least a portion of the plasma torch is in the liquid and oriented such that the plasma plume produced by the plasma torch is within the liquid, preferably entirely within the liquid. In some embodiments the liquid is designed to further serve as a coolant for the plasma torch and/or the plasma torch nozzle. For inductively coupled plasma torches, the plasma power sources can be radio frequency (RF) or microwave frequency using a magnetron and waveguides. A low temperature atmospheric pressure plasma jet can be used to lower the temperature of plasma plume to minimize thermal cracking and consequent polymerization. The electrodes can have a dielectric barrier in between two metallic electrodes, and AC or pulsed power source.

The plasma torch can produce a plasma plume to cause the reformation of the hydrocarbons in or near the plasma plume. The plasma plume can be a high-temperature plasma plume, e.g. can have a temperature of 400K-4000K, 450K-3500K, 500K-3000K, 550K-3000K, 600K-3000K, 700K-3000K, or 750K-2500K. In some embodiments the device can include a perforate plate positioned within the plasma plume. The perforate plate can be made of any material capable of withstanding the temperatures of the plasma plume, e.g. a suitable ceramic plate having a plurality of perforations. The perforate plate can dissipate the plume to provide a more uniform heating and/or can facilitate dissipation of gas bubbles to form smaller gas bubbles.

The plasma torch can be positioned in a variety of positions within the liquid container. The plasma torch can be positioned near the bottom portion, top portion, or a side portion of the container. The plasma torch can be near the bottom portion of the container and the configured to be upwardly submerged in the liquid. The plasma torch can be near the top portion of the container and configured to be downwardly submerged in the liquid. The plasma torch can be near a side portion of the container and configured to be laterally submerged in the liquid. The device can include more than one plasma torch, each near a different side portion of the container. In some embodiments, one or more plasma torches can be configured to generate mixing in the liquid when in the liquid container.

The device can include one or more inlets and/or one or more outlets, optionally including one or more valves, to control the flow of liquids and gases in and out of the container. The device can include a fluid inlet having an inlet valve. The inlet valve can be used to control the flow of liquid into the container. The device can include a fluid outlet and an outlet valve. The outlet valve can control the flow of liquid out of the container. The device can include an outlet to allow for venting and/or removal of gases.

The liquid container can be any container capable of withstanding the temperatures and that is relatively inert with respect to the hydrocarbons and liquids. The liquid container can optionally include a temperature apparatus to control the temperature of the liquid in the liquid container. The cooling apparatus can include a temperature controlled air bath, an ice bath, or an oil bath. The temperature of the liquid can be maintained at any suitable temperature below the boiling point of the liquid and greater than the freezing point of the liquid, e.g. about 0° C. to 100° C., about 10° C. to 100° C., about 10° C. to 90° C., or about 20° C. to 80° C.

The liquid container can hold a liquid. In some embodiments the liquid is a water or an aqueous liquid, e.g. containing predominately water. The liquid can include a liquid hydrocarbon source. Liquid hydrocarbons include linear, branched, and cyclic hydrocarbons that are liquid at standard temperature and pressure, including propane, n-butane, isobutane, n-hexane, n-octane, n-decane, n-tridecane, benzene, toluene, ethyl benzene, cyclohexane, derivatives thereof, and mixtures thereof. Liquid hydrocarbons can include mixtures such as naptha, gasoline, kerosene, diesel oil, crude oil, heavy fuel oil, or combinations thereof.

The device can include a gas source. The gas source can include additive gases, such as gases for the plasma torch and/or gases for the hydrocarbon reformation. The gas source can also include a gaseous hydrocarbon source. In some embodiments the device includes a gas bubble generator fluidly connected to a gas source. In some embodiments the gas bubble generator is built into the plasma torch, for example into a nozzle or electrode of the plasm torch. For example, one or both of the electrodes of the plasma torch can be a porous electrode or can otherwise have one or more openings coupled to the gas source. The bubbles can be generated from such an electrode. The bubbles can have any size, but will generally be about 1 cm in diameter or less and/or about 10 μm in diameter or more. The bubbles can have a diameter of about 10 μm to 1 cm, about 100 μm to 1 cm, about 100 μm to 9000 μm, about 1000 μm to 9000 μm, or about 2000 μm to 8000 μm. The gas bubble generator can be configured to generate gas bubbles that pass through the liquid and into the plasma plume of the plasma torch.

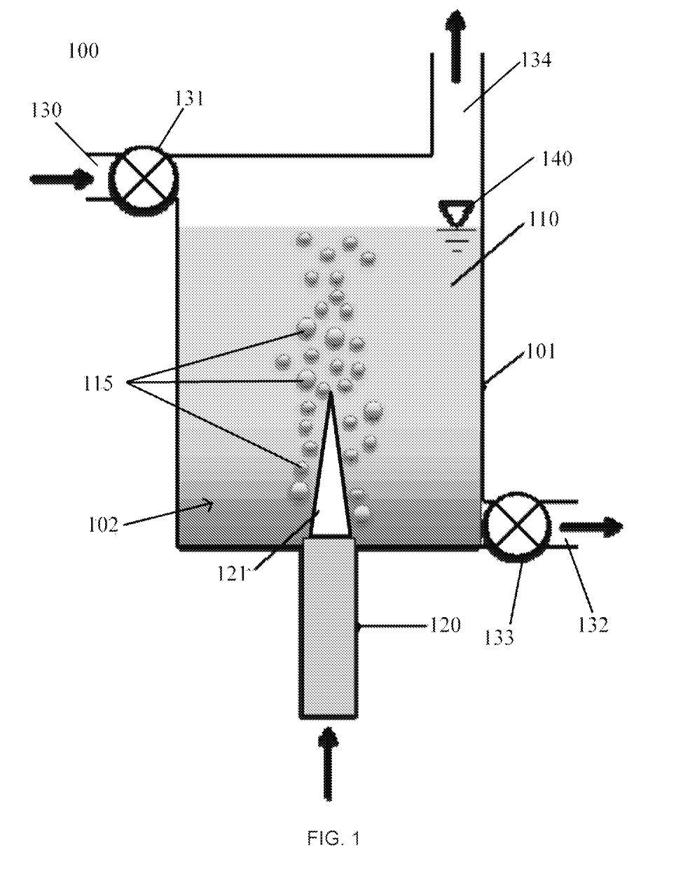

FIG. 1 is a diagram of one embodiment of a plasma device 100 for hydrocarbon reformation including a liquid container 101 and single plasma torch 120 near the bottom portion of the liquid container 102 such that it is upwardly submerged in a liquid 110 contained within the container 101. The container 101 includes an upper fluid inlet 130 having an inlet valve 131 to allow for and control the introduction of liquids into the container 101. The container 101 includes a lower fluid outlet 132 having an outlet valve 133 to allow for and control the removal of liquids from the container 101. The container 101 includes a top outlet 134 to allow for the venting and removal of gases. Gas bubbles 115 in the liquid 110 can be generated by a suitable gas bubble generator (not pictured) or by the vaporization of one component of the liquid by the heat of the plasma plume 121. The plasma plume 121 can cause the reformation of hydrocarbons, including both liquid hydrocarbons contained within the liquid 110 and gaseous hydrocarbons contained within the gas bubbles 115. Gaseous products can be removed through the top outlet 134 while liquid products can be removed through the lower fluid outlet 132. The device can include a sensor 140 within the container 101 to detect the level of the liquid 110. The sensor can be in communication with a control unit (not pictured) that controls the inlet valve 131 and the outlet valve 133.

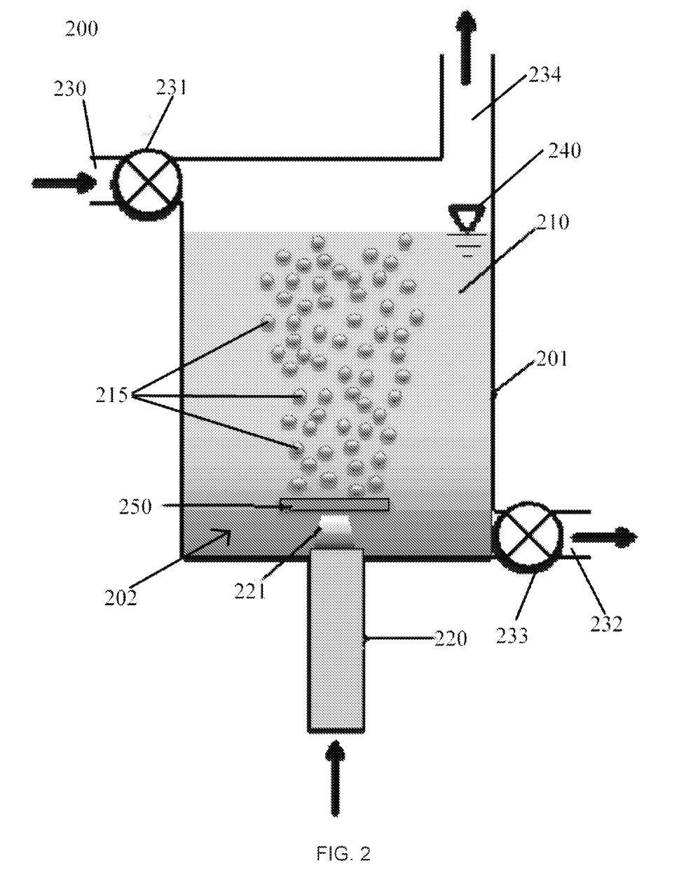

FIG. 2 is a diagram of one embodiment of a plasma device 200 for hydrocarbon reformation including a liquid container 201 and single plasma torch 220 near the bottom portion of the liquid container 202 such that it is upwardly submerged in a liquid 210 contained within the container 201. The container 201 includes an upper fluid inlet 230 having an inlet valve 231 to allow for and control the introduction of liquids into the container 201. The container 201 includes a lower fluid outlet 232 having an outlet valve 233 to allow for and control the removal of liquids from the container 201. The container 201 includes a top outlet 234 to allow for the venting and removal of gases. Gas bubbles 215 in the liquid 210 can be generated by a suitable gas bubble generator (not pictured) or by the vaporization of one component of the liquid by the heat of the plasma plume 221. The device 200 can include a perforate plate 250 positioned within the plasma plume 221 to dissipate the core of the plasma plume 221 and/or to generate finer gas bubbles within the liquid. The plasma plume 221 can cause the reformation of hydrocarbons, including both liquid hydrocarbons contained within the liquid 210 and gaseous hydrocarbons contained within the gas bubbles 215. Gaseous products can be removed through the top outlet 234 while liquid products can be removed through the lower fluid outlet 232. The device can include a sensor 240 within the container 201 to detect the level of the liquid 210. The sensor can be in communication with a control unit (not pictured) that controls the inlet valve 231 and the outlet valve 233.

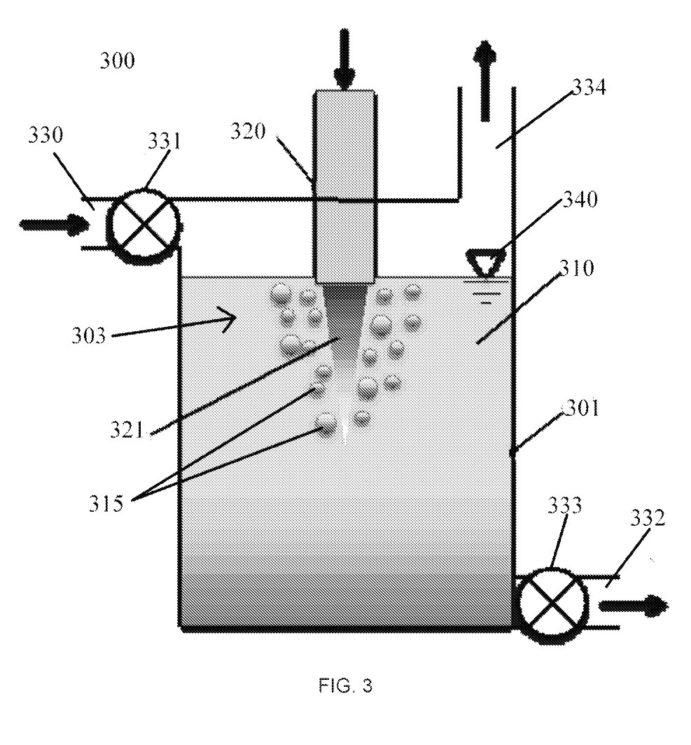

FIG. 3 is a diagram of one embodiment of a plasma device 300 for hydrocarbon reformation including a liquid container 301 and single plasma torch 320 near the top portion of the liquid container 303 such that it is upwardly submerged in a liquid 310 contained within the container 301. The container 301 includes an upper fluid inlet 330 having an inlet valve 331 to allow for and control the introduction of liquids into the container 301. The container 301 includes a lower fluid outlet 332 having an outlet valve 333 to allow for and control the removal of liquids from the container 301. The container 301 includes a top outlet 334 to allow for the venting and removal of gases. Gas bubbles 315 in the liquid 310 can be generated by a suitable gas bubble generator (not pictured) or by the vaporization of one component of the liquid by the heat of the plasma plume 321. The plasma plume 321 can cause the reformation of hydrocarbons, including both liquid hydrocarbons contained within the liquid 310 and gaseous hydrocarbons contained within the gas bubbles 315. Gaseous products can be removed through the top outlet 334 while liquid products can be removed through the lower fluid outlet 332. The device can include a sensor 340 within the container 301 to detect the level of the liquid 310. The sensor can be in communication with a control unit (not pictured) that controls the inlet valve 331 and the outlet valve 333.

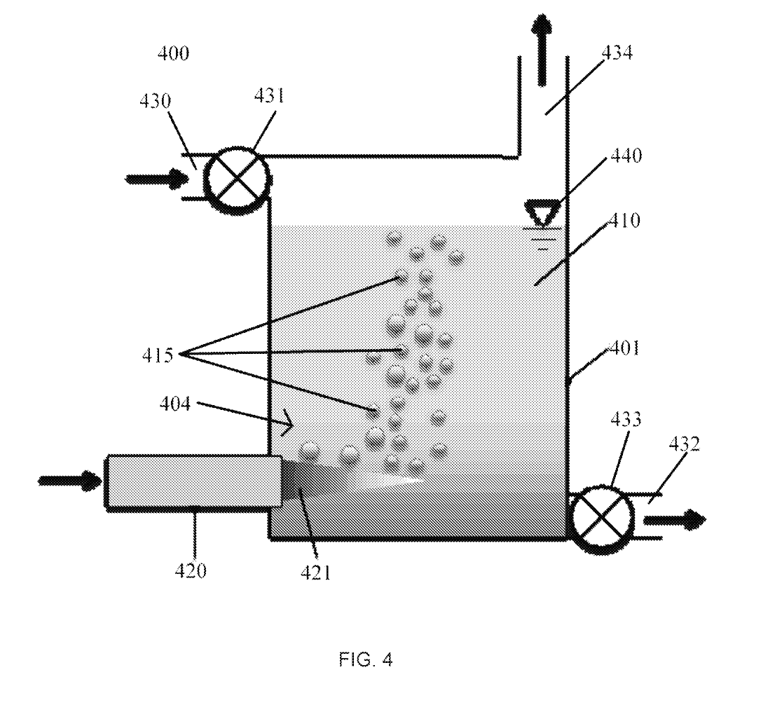

FIG. 4 is a diagram of one embodiment of a plasma device 400 for hydrocarbon reformation including a liquid container 401 and single plasma torch 420 near a side portion of the liquid container 404 such that it is upwardly submerged in a liquid 410 contained within the container 401. The container 401 includes an upper fluid inlet 430 having an inlet valve 431 to allow for and control the introduction of liquids into the container 401. The container 401 includes a lower fluid outlet 432 having an outlet valve 433 to allow for and control the removal of liquids from the container 401. The container 401 includes a top outlet 434 to allow for the venting and removal of gases. Gas bubbles 415 in the liquid 410 can be generated by a suitable gas bubble generator (not pictured) or by the vaporization of one component of the liquid by the heat of the plasma plume 421. The plasma plume 421 can cause the reformation of hydrocarbons, including both liquid hydrocarbons contained within the liquid 410 and gaseous hydrocarbons contained within the gas bubbles 415. Gaseous products can be removed through the top outlet 434 while liquid products can be removed through the lower fluid outlet 432. The device can include a sensor 440 within the container 401 to detect the level of the liquid 410. The sensor can be in communication with a control unit (not pictured) that controls the inlet valve 431 and the outlet valve 433.

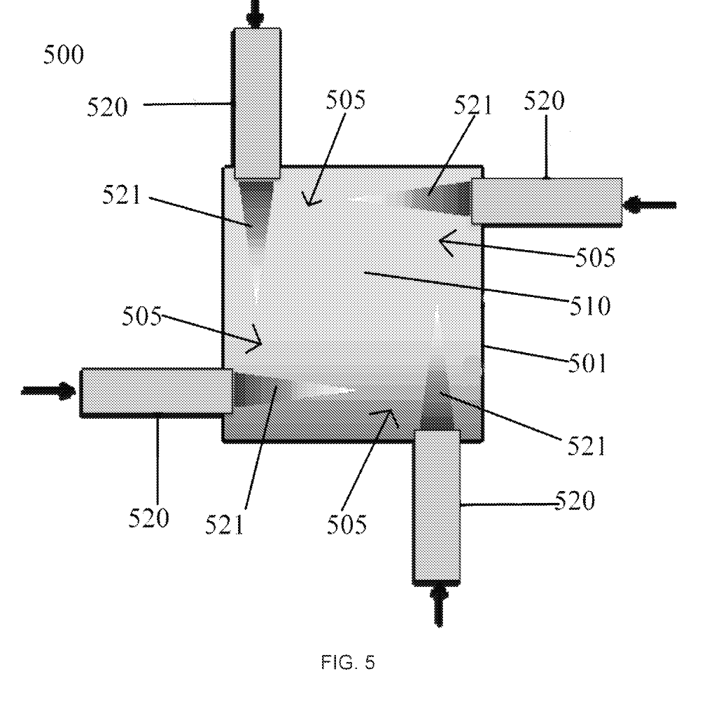

FIG. 5 is a top view of one embodiment of a plasma device 500 for hydrocarbon reformation including a liquid container 501 and having four plasma torches 520 each near a different side portion of the liquid container 505 such that each is laterally submerged in a liquid 510 contained within the container 501.

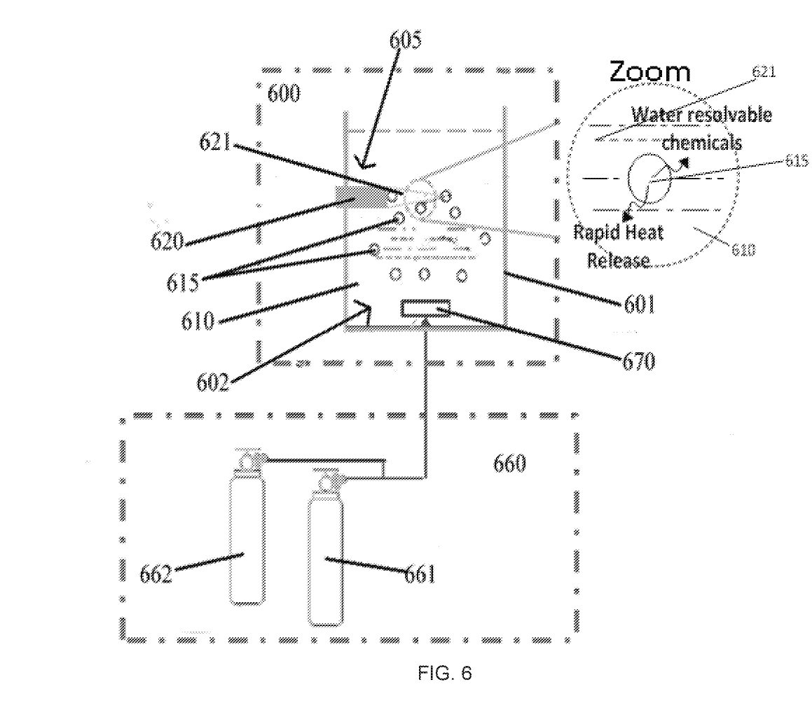

FIG. 6 is a diagram of one embodiment of a plasma device 600 for the reformation of gaseous hydrocarbons including a liquid container 601 and having a plasma torch 620 near a side portion of the liquid container 605 such that it is laterally submerged in a liquid 610 contained within the container 601. A gas bubble generator 670 is positioned near the bottom portion of the liquid container 602 such that the gas bubbles 615 generated pass through the liquid 610 and into the plasma plume 621. The gas bubble generator 670 is fluidly connected to a gas source 660 including a gaseous hydrocarbon source 661 and, optionally, and additive gas source 662. The plasma plume 621 can cause the reformation of gaseous hydrocarbons contained within the gas bubbles 615. As shown in the inset, an aqueous liquid 610 can provide for rapid heat release, solvation of water resolvable chemicals produced, and/or prevention of radical termination during the reformation of the gaseous hydrocarbons as the gas bubbles 615 pass through the plasma plume 621.

### Methods of Reformation of Hydrocarbons

Methods of reformation of hydrocarbons are provided. The methods can include introducing a hydrocarbon into the liquid container of any one of the devices described herein and applying the plasma plume of the plasma torch to the hydrocarbon to cause reformation of the hydrocarbon.

The methods can include reformation of gaseous hydrocarbons. A gaseous hydrocarbon and an additive gas can be mixed and flow into a gas bubble generator where bubbles are generated containing the gaseous hydrocarbon and the additive gas. The bubbles can be generated in a container containing a liquid in such a way that the bubbles pass through a plasma plume. The liquid can provide many benefits including the sorption of water resolvable chemicals, the prevention of hydrogen radical termination, and/or rapid cooling of the high temperatures produced by the electrical discharge. The gaseous hydrocarbons can include any gaseous hydrocarbon source that is a gas at the operable temperature where the method is performed. Preferably, the gaseous hydrocarbon is or contains a hydrocarbon that is a gas at about room temperature, e.g. is a gas at about 20° C., about 21° C., 22° C., 23° C., or less. The gaseous hydrocarbon can include a hydrocarbon having from 1 to 8, 1 to 7, 1 to 6, or 1 to 5 carbon atoms, The gaseous hydrocarbon can include methane, ethane, propane, butane, ethene, propene, butene, ethyne, propyne, butyne, or a mixture thereof. The gaseous hydrocarbon can be essentially pure, i.e. contains essentially just a single type of hydrocarbon and about 5 mol-%, 3 mol-%, 2 mol-%, 1 mol-%, or less of other molecules.

The methods can include reformation of liquid hydrocarbons. The liquid hydrocarbons can be introduced into the liquid container, optionally including one or more additional liquids such as water or an aqueous liquid. Suitable liquid hydrocarbons can include propane, n-butane, isobutane, n-hexane, n-octane, n-decane, n-tridecane, benzene, toluene, ethyl benzene, cyclohexane, derivatives thereof, and mixtures thereof. Liquid hydrocarbons can include mixtures such as naptha, gasoline, kerosene, diesel oil, crude oil, heavy fuel oil, or combinations thereof.

The reformation of the hydrocarbon can produce a lower hydrocarbon, a higher hydrocarbon, oxygenates, H₂, CO, H₂O, CO₂, or a mixture thereof. The hydrocarbon produced can include ethane, ethylene, propane, propylene, and mixtures thereof. The reformation can produce syngas, naptha, gasoline, kerosene, diesel oil, or mixtures thereof.

The reformation of the hydrocarbon can produce about 15 mol-%, 12 mol-%, 10 mol-%, 8 mol-%, 6 mol-%, 5 mol-%, 4 mol-%, 3 mol-%, 2 mol-%, 1 mol-%, or less of CO₂ and H₂O. The reformation of the hydrocarbon can produce about 5 mol-%, 10 mol-%, 15 mol-%, 20 mol-%, 25 mol-%, or more of the lower hydrocarbon. The reformation of the hydrocarbon can produce about 5 mol-%, 10 mol-%, 15 mol-%, 20 mol-%, 25 mol-%, or more of the higher hydrocarbon. The reformation of the hydrocarbon can produce about 30 mol-%, 40 mol-%, 50 mol-%, 60% mol-%, 70 mol-%, 80 mol-%, or more of H₂.

The liquid can typically be any liquid that will support hydrocarbon reformation in the plasma plume. The liquid can have an electrical conductivity from about 01 μS/cm to about 1000000 μS/cm, e.g. about 0.1 μS/cm to 500000 μS/cm, about 0.5 μS/cm to 500000 μS/cm, about 1 μS/cm to 500000 μS/cm, about 1 μS/cm to 100000 μS/cm, about 1 μS/cm to 50000 μS/cm, about 10 μS/cm to 50000 μS/cm, or about 10 μS/cm to 1000 μS/cm. The methods can also be performed with liquids of varying pH ranging from 0 to 14, e.g. about 1 to 13, 2 to 12, 2 to 11, 3 to 11, 4 to 11, 4 to 10, 5 to 9, or 5.5 to 8.5. The liquid can be water or can be an aqueous based medium.

The bubble can also be generated containing one or more additive gases. The additive gases and their percentage of the total gas in the bubble can be varied to impact the production of desired products and/or the efficiency of the reformation process. For example, the amount of additive gas can be varied to control the overall C/O ratio in the mixture of gases in the bubble. Typical additive gases can include, for example, molecular oxygen (O₂), carbon dioxide (CO₂), helium, argon, nitrogen, gaseous hydrocarbons such as methane, ethane, or propane, and mixtures thereof. The additive gas can be about 10% (w/w) of the bubble to 100% of the bubble. The additive gas can be about 10%-100%, 10%-95%, 15%-95%, 15%-90%, or 20%-80% (w/w) of the bubble.

The methods can include controlling the temperature of the liquid to prevent or control the amount of heating caused by the plasma plume. The temperature can be any temperature from about 0° C. to slightly below the boiling point of the liquid, e.g. about 100° C. or less. The temperature can be controlled to about 10° C.-20° C., about 20° C.-30° C., about 30° C.-40° C., about 40° C.-50° C., about 50° C.-60° C., about 60° C.-70° C., about 70° C.-80° C., about 80° C.-90° C., about 90° C.-100° C., or any combination thereof. The temperature of the liquid can be controlled using an air bath, an ice bath, or a liquid bath. The use of the liquid, optionally including controlling the temperature of the liquid, can provide rapid cooling of the liquid and/or the bubble after the electrical discharge. The cooling can be, for example, at about 10⁸ K/s to 10¹⁰ K/s.

For example, a gas mixture containing natural gas and additive gas (e.g. oxygen and carbon dioxide) can be injected into the liquid container containing water or an aqueous liquid. The gas mixture can be injected into the container so that gas bubbles are produced in the aqueous medium. When the plasma plume is ignited in the gas bubbles, hydrocarbon radicals, such as CH₃, CH₂ and CH radicals are produced from natural gas, O atoms are produced from additive gas, and OH radicals are produced from water. Chemical reactions between hydrocarbon radicals, O atoms and OH radicals lead to the production of value-added chemicals such as heavier hydrocarbons (e.g. ethane and ethylene), and syngas, H₂ and CO, and complete oxidation products, H₂O and CO₂.

For example, a liquid mixture containing a liquid hydrocarbon and water or an aqueous liquid can be injected into the container. An additive gas (e.g. oxygen and carbon dioxide) can be injected into the liquid container through the plasma torch or through a bubble generator. The gas mixture can be injected into the container so that gas bubbles are produced in the aqueous medium. When the plasma plume is ignited in the liquid, hydrocarbon radicals, such as CH₃, CH₂ and CH radicals are produced from the liquid hydrocarbon source, O atoms are produced from additive gas in the gas bubbles, and OH radicals are produced from water. Chemical reactions between hydrocarbon radicals, O atoms and OH radicals lead to the production of value-added chemicals such as higher hydrocarbons, lower hydrocarbons (e.g. ethane and ethylene), and syngas, H₂ and CO, and complete oxidation products, H₂O and CO₂.

The evaporation of water can quickly take away the heat produced from plasma, resulting in a very rapid cooling of reaction temperature (˜10⁹-10¹⁰ K/s), and which can also lead to a high selectivity of heavier hydrocarbons and/or a low selectivity of hydrogen and carbon monoxide

The presence of water can facilitate H₂ production because H radical can be produced from the water decomposition, and increased initial concentration of H₂O can minimize radical quenching reaction like H+OH→H₂O.

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figure of the numerical value. In addition, the phrase “about ‘x’ to ‘y’” includes “about ‘x’ to about ‘y’”.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A device for hydrocarbon reformation, the device comprising
a liquid container configured to hold a liquid and to receive the hydrocarbon from a hydrocarbon source,
a plasma torch in the liquid container configured to be submerged in the liquid, wherein a plasma plume from the plasma torch causes reformation of the hydrocarbon.

2-5. (canceled)

6. The device of claim 1, wherein the plasma torch is configured to generate mixing in the liquid when in the liquid container.

7. The device of claim 1, further comprising:
a perforate plate positioned within the plasma plume of the plasma torch.

8. The device of claim 1, further comprising:
a fluid inlet having an inlet valve;
a fluid outlet having an outlet valve; and
an outlet to allow for venting and/or removal of gases.

9-11. (canceled)

12. The device of claim 1, further comprising:
a gas bubble generator.

13. The device of claim 12, wherein the gas bubble generator is fluidly connected to a gaseous hydrocarbon source.

14. The device of claim 12, wherein the gas bubble generator is fluidly connected to an additive gas source.

15. The device of claim 12, wherein the gas bubble generator is configured to generate gas bubbles that pass through the liquid and into the plasma plume of the plasma torch when the liquid is in the liquid container.

16. (canceled)

17. A method of reformation of a hydrocarbon, the method comprising
introducing the hydrocarbon into a liquid container holding a liquid and receiving the hydrocarbon from a hydrocarbon source; and
applying a plasma plume of a plasma torch to the hydrocarbon to cause reformation of the hydrocarbon, wherein the plasma torch is submerged in the liquid in the liquid container.

18. The method of claim 17, further comprising:
introducing an additive gas into the liquid container prior to or while applying the plasma plume of the plasma torch to the hydrocarbon.

19. The method of claim 18, wherein the additive gas is selected from the group consisting of molecular oxygen (O₂), carbon dioxide (CO₂), and mixtures thereof.

20. The method of claim 17, wherein the reformation of the hydrocarbon produces a lower hydrocarbon, oxygenates, H₂, CO, H₂O, CO₂, or a combination thereof.

21. The method of claim 20, wherein the lower hydrocarbon is selected from the group consisting of ethane, ethylene, propane, propylene, and mixtures thereof.

22. The method of claim 17, wherein the reformation of the hydrocarbon produces a syngas.

23. The method of claim 17, the method further comprising:
cooling the liquid and/or bubbles in the liquid at a rate of about 10⁸ K/s to 10¹⁰ K/s.

24. The method of claim 17, wherein the reformation of the hydrocarbon produces about 15 mol-% or less of CO₂ and H₂O.

25. The method of claim 17, wherein the reformation of the hydrocarbon produces about 20 mol-% or more of the lower hydrocarbon.

26. The method of claim 17, wherein the reformation of the hydrocarbon produces about 60% mol-% or more of H₂.

27. The method of claim 17, wherein the hydrocarbon is a gaseous hydrocarbon.

28. The method of claim 17, wherein the hydrocarbon is a liquid hydrocarbon.
